(19) United States
(12) Patent Application Publication
(10) Pub. No.: US 2009/0228543 A1
(43) Pub. Date: Sep. 10, 2009

(54) Agent representative for the internet

(76) Inventor: Dana S. Collum, Andalusia, AL (US)

Correspondence Address: David E. Orr, 4616 NE 134th Street, Vancouver, WA, 98686, US

(21) Appl. No.: 12/074,519

(22) Filed: Mar. 5, 2008

(51) Int. Cl. G06F 15/16

(52) U.S. Cl. 709/201

(57) ABSTRACT

An Internet mobile agent for representing a shopper is disclosed. The agent comprises objects having methods that are called by a server visited by the agent. By calling the methods a server can determine needs, wants and physical characteristics of the shopper. The server finds matches of items for sale, and sends mathematical descriptions of the matching items back to the shopper. Mapping algorithms map the items to representations of the shopper's body carried by the agent.

### FIELD

The present invention is an intelligent agent comprised of portable executable software objects for representing a user on the Internet. The agent searches the Internet for items and information of interest to the user, and may interact with web-sites by the web-site servers calling methods on the agent's objects, which carry mathematical descriptions of the agents physical and psychological attributes. Goods and services for sale on a web-site may have mathematical descriptions, which are mapped to mathematical descriptions of the agent, wherein the goodness-of-fit of the mathematical mapping are used to convey an appropriateness of the web-site's offerings to the user needs represented by the agent.

### BACKGROUND

Items and services bought on the Internet are an exponentially increasing portion of international commerce. The predominant method of locating merchandise and services of interest is by search engines. Shopping by search engines is time consuming. Furthermore the look, feel and features of the article sought are not well represented at merchant web-sites.

What is needed and has not yet been provided is a means of shopping wherein a shopping agent may be used; the shopping agent representing the knowledge, needs, and wants, as well as the physical and financial attributes of the actual shopper.

### OBJECTS AND ADVANTAGES

It is, therefore, an object of the present invention, to provide a system and method for interactive shopping, wherein the agent is mobile, comprised of executable software objects, and may interact in simulated shopping behavior with a merchant web-site.

A second object and advantage of the invention is a mobile shopping agent that is motivated by conveying to the merchant's web-site, the shopper's needs, wants and desires, which may be ascertained by the merchant's server by calling methods on the agent's objects.

A third object and advantage is a mobile agent having a mathematically described physical body (representing the user) and a psychology (representing the user), wherein the merchant's server may ascertain psychological and physical aspects of the shopping agent by calling methods on the objects comprising the agent.

A fourth object and advantage is a merchant's catalog of wares and services that are described mathematically.

A fifth advantage is a plurality of mathematical operators for mapping representations of merchant's wares to mathematical representations of the shopping agent.

A sixth object and advantage is a mobile shopping agent that may show a shopper the merchant's wares by mapping the mathematically described wares to the agent's mathematically described physical and psychological attributes.

A seventh object and advantage is a system and method for assigning a weight to the mapping to represent a goodness of fit of the mapping.

And another advantage and benefit is an agent that may be empowered by a person to represent the person in a business transaction.

And another advantage is the agent may use the goodness of fit to represent the person in the business transaction.

And yet another advantage and benefit is an agent that may be endowed with a user's characteristics by accessing a database residing at the person's web-site.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

In an exemplary embodiment, a shopping agent comprising a mobile software system that deployed from a user's computer. In an exemplary embodiment, the agent resides at the user's web-site however the agent may reside at a second web-site and may be “rented” to the user.

Agent object attributes may be populated by the agent's object calling methods on an object database at the user's site, thereby facilitating the agent's assuming characteristics appropriate to a time and web-site visited by the agent.

The shopping agent is comprised of three categories of mobile executable software objects. The first category is objects describing the shopping agent's psychology comprising wants need or desires. The second category is objects describing physical features of the shopping agent. And the third category comprises objects that represent the degree to which the agent is empowered to encumber the user. An example is a shopping budget.

The system and method may be used to facilitate a shopping agent visiting a merchant-related web-site and returning back to the user's computer with software representations of merchandise offered at the merchant's web site. For example, the agent may shop for clothes and return software representations (images) of the clothes. Or the agent may obtain, return and play or sing snippets of a song.

The shopping agent may be launched from a user's computer to visit a merchant web-site, where the merchant server queries methods defined on the agent's first category of objects to determine the wants or needs of the agent. The results of the wants or needs query may used to search a database at the merchant's site to find an item or service that matches the agent's wants or needs.

If a match is found, a mathematical description of the matching item is retrieved. The mathematical description also includes a physical or psychological part of the agent to which the item is related. The physical or psychological part of the agent determines an agent object and method to call to obtain the mathematical description of the related agent part, which are used by a set of mapping operators to map the mathematical description of the item to the related agent part.

When a match is found the merchant's server may query the agent to determine the amount the agent is empowered to spend for the item. If the item costs—more than the agent is empowered to spend the merchant may post the result of “unable to comply with budget” to the agent by calling a method on the agent's objects.

The agent may be created and operated in two different environments. In a first environment, the agent resides on a user's computer and is launched by commands issued by the user. In a second environment, the agent may reside on a server remote to the user's computer, and is launched by the user communicating with the remote server.

A merchant's environment for interacting with an agent may also be implemented in two environments. A merchant's server may be programmed to interact with an agent, or a remote server may be programmed to interact with an agent on behalf of the merchant.

A disclosure of the specific features and functionality of a mobile agent follow in the detailed description that follows, with references to the drawings that accompany this written description.

### BRIEF DESCRIPTION OF DRAWINGS

FIG. 1A depicts the object structure of the agent.

FIG. 1B represents the serialization of the agent for transport and execution over a network.

FIG. 2 represents a possible computing environment for practicing the invention.

FIG. 3A represents a mathematical description of a curve or surface, for example using a Bezier function.

FIG. 3B shows the Bezier function of FIG. 3A after a mathematical transform.

FIG. 4 is a flow diagram of the mapping of a web-site item for sale to the agent's body.

### DETAILED DESCRIPTION

### An Exemplar Embodiment

In an exemplary embodiment, a shopping agent is disclosed, wherein the agent comprises mobile executable code that may be transferred across the Internet from a first computer to a second computer, and then executed on the second computer.

The shopping agent transports four categories of mobile executable software objects. The first category describes the shopping agent's psychology such as motives. The second category is objects describing physical features of the shopping agent, such as body structure, body features and geometry. The third category defines the agent's persona, which mirrors that of the user or owner of the agent. And the fourth category defines a user's budget for expenditures or willingness to buy based upon cost.

Mobile agent operability is achieved though the use of application frameworks, such as CORBA and JINI.

CORBA (Common Object Request Broker Architecture) is an architecture and specification for creating, distributing, and managing distributed program objects in a network. Through CORBA programs at different locations and developed by different vendors to communicate in a network through an “interface broker.” CORBA was developed by a consortium of vendors through the Object Management Group (OMG), which currently includes over 500 member companies. Both International Organization for Standardization (ISO) and X/Open have sanctioned CORBA as the standard architecture for distributed objects (which are also known as components). CORBA 3 is the latest level.

The essential concept in CORBA is the Object Request Broker (ORB). ORB support in a network of clients and servers on different computers means that a client program (which may itself be an object) can request services from a server program or object without having to understand where the server is in a distributed network or what the interface to the server program looks like. To make requests or return replies between the ORBs, programs use the General Inter-ORB Protocol (GIOP) and, for the Internet, its Internet Inter-ORB Protocol (IIOP). IIOP maps GIOP requests and replies to the Internet's Transmission Control Protocol (TCP) layer in each computer.

JINI is a distributed object technology developed by Sun Microsystems Inc. JINI provides tools and mechanisms to build a dynamic distributed object system where every component is either a service or a consumer of a service. JINI services are programmed with Java interfaces and all service operations can be accessed via those interfaces. JINI provides a Service Oriented Architecture (SOA) where the three main components are the Service, the Client and the Registry which is called Lookup Service in JINI terminology. When a Service starts up it registers its proxy service with the Lookup Service which is a plain Java object implementing the service interfaces and wraps a remote reference to the service backend. The proxy object hides all communication details to the service backed and makes JINI protocol independent, since any communication protocol can be implemented between the proxy and the service backend. After registering with the Lookup Services clients can lookup the suitable service based on the interface description. Software clients can subscribe for remote events that are triggered when the required service appears or disappears.

By employing transportable object software frameworks, such as JINI or CORBA, the shopping agent visits a merchant web-site, where the merchant server queries methods defined on the agent's motivational objects to determine the wants or needs of the agent. The results of the wants or needs query is used to search a database to find an item or service that matches the agent's wants or needs.

If a match is found, a mathematical description of the matching item is retrieved. The mathematical description also includes a physical part of the agent to which the item is related. The physical part designated defines an object and method carried by the shopping agent.

A set of mapping operators are employed to map the mathematical description of the item to the related agent part.

Software technology that may be used for the portable agent is described in the following narrative. The following description is exemplary and should not be construed to a limitation of the functionality or capabilities of the mobile agent of the first embodiment.

### Mobile Agents

Mobile software agents are programs that reside in computer networks, carrying out goal-directed computation while moving from host to host. Mobile software agents in general have gained acceptance as a way to perform computations. Mobility for software agents is more controversial, in large part because of the complexity and security risks mobility implies.

Mobile agents provide a novel, compelling way to organize the use of distributed resources on the Internet. Using object-oriented programming languages, such as Java and C#, software agents may be designed according to a “super-object-oriented” paradigm. Traditional object-oriented programming collect data and code in one (typically small) object. Software agents wrap up a large amount of data and code into one package; in this sense, a software agent is like a large object. Agents not only encapsulate state and rules; they also have purpose and autonomy. An agent is a way to encapsulate a computational task. A mobile agent can be sent over the network to use needed resources on a remote host. The agent metaphor makes it easier to understand the organization of distributed computations.

As an example of a distributed computation performed by agents, consider the construction of a computer animation where several different resources distributed across the Internet are needed. An agent could be programmed to first visit the character store at Disney to purchase model data. The agent then takes the data to a render farm where it would spawn many agents on the rendering machines to create the frames. Finally, the agent collects all the frames and takes them over to a host with specialized MPEG creation capability to package the final movie. By describing this computation in terms of mobile agent intentionality it is easy to understand how the various resources are coordinated to perform the task.

Java system from Sun Microsystems is a system that may be used to implement a portable agent today. Java is a combination language and operating system that has working implementations and a large degree of market acceptance. However, an equivalent system such as the Microsoft .NET framework may also be used.

Java achieves portability by executing instructions (bytecode) on a hypothetical virtual machine. Any computer having the virtual machine (whether Microsoft-based PC, Apple Mac or Linux system) may execute a portable program comprised of bytecodes. Java bytecode is the form of instructions that the Java virtual machine executes. Each bytecode instruction is one byte in length (hence the name), thus the number of bytecodes is limited to 256. Java bytecode is the form of instructions that the Java virtual machine executes. Each bytecode instruction is one byte in length (hence the name), thus the number of bytecodes is limited to 256. Not all 256 possible bytecode values are used. In fact, Sun Microsystems, the original creators of the Java programming language, the Java virtual machine and other components of the Java Runtime Environment, have set aside a number of values to be permanently unimplemented.

Mobile Java programs are transported from computer to computer on a network as bytecode. Bytecodes are a simple stack language that is interpreted by a virtual machine (an interpreter) on the computer.

Mobile programs that execute on a Java virtual machine must be compiled into a standardized portable binary format, which typically comes in the form of class files. A program may consist of many classes in different files. For easier distribution of large programs, multiple class files may be packaged together in a “jar” (Java archive) file.

A basic philosophy of Java is that it is inherently safe from the standpoint that no user program can crash the host machine or otherwise interfere inappropriately with other operations on the host machine, and that it is possible to protect certain functions and data structures belonging to trusted code from access or corruption by untrusted code executing within the same Java virtual machine. Furthermore, common programmer errors that often lead to data corruption or unpredictable behavior (accessing off the end of an array, using an uninitialized pointer, etc) are not allowed to occur. Several features of Java combine to provide this safety, including the class model, the garbage-collected heap, and the verifier—the Java virtual machine verifies all bytecode before it is executed.

### Implementation of the Mobile Agent-Software Objects

In the programming paradigm of object-oriented programming, an object is the individual run-time unit that is used as the basic building block of programs. These objects act on one another, as opposed to a traditional view in which a program may be seen as a collection of functions, or simply as a list of instructions to the computer. Each object is capable of receiving messages, processing data, and sending messages to other objects. Each object can be viewed as an independent machine or actor with a distinct role or responsibility.

An object is an instantiation (instance) of a class. A class is a blueprint offering a defined functionality. That functionality is actually implemented by creating an instance of that class, in form of an object. For example, in object-oriented programming (OOP) an engineering diagram of a computer monitor is a class. The actual computer monitor any particular computer user is looking into is an instance of that class, an object. Multiple objects of the monitor class can be created, each using the functionality defined by the class.

In OOP, an instance of a program (i.e. a program running in a computer) is treated as a dynamic set of interacting objects. Objects in OOP extend the more general notion of objects described above to include a very specific kind of typing, which among other things allows for:

1. Data members that represent the data associated with the object.

2. Methods that access or process data members in predefined ways.

In the case of most objects, the data members can only be accessed through the methods, guaranteeing that the data will always remain in a well-defined state meaning class invariants will be enforced.

### Implementation of the Mobile Agent-Mobility Through Object Serialization

Serialization is the process of saving an object onto a storage medium (such as a file, or a memory buffer) or to transmit it across a network connection link in binary form. The series of bytes or the format can be used to re-create an object that is identical in its internal state to the original object, that is, the serialized object is a clone of the original object.

This process of serializing an object is also called deflating or marshaling an object. The opposite operation, extracting a data structure from a series of bytes, is deserialization, which is also called inflating or unmarshalling.

Java provides automatic serialization which requires that the object be marked by implementing the java.io.Serializable interface. Implementing the interface marks the class as “okay to serialize,” and Java then handles serialization internally. There are no serialization methods defined on the Serializable interface, but a serializable class can optionally define methods with certain special names and signatures that if defined, will be called as part of the serialization/deserialization process.

The standard Java serialization encoding method uses a simple translation of the fields into a byte stream. Primitives as well as non-transient, non-static referenced objects are encoded into the stream. Each object that is referenced by the serialized object and not marked as transient must also be serialized; and if any object in the complete graph of non-transient object references is not serializable, then serialization will fail. The developer can influence this behavior by marking objects as transient, or by redefining the serialization for an object so that some portion of the reference graph is truncated and not serialized.

### Method of Implementing Physicality of the Agent

The mobile agent may be implemented as three categories of classes of objects:
1. “Motivational” classes of interests and desires
2. Classes of physical features including body geometry and dimensions.
3. Classes of financial or budgetary representations that indicate the willingness of the agent (representing the user) to spend or acquire based upon a goodness of fit of the mapping of a web-site's wares to the agent.

A mobile agent is comprised of portable classes of bytecode objects, and methods defined on the software objects. Methods on the agent's objects are called by a server visited by the agent.

The wants, needs and desires of the agent may be determined by the server (where the agent visits) calling a method on the agent's interests and desires classes. The server may determine some aspect of the agent's physical structure by the server calling an appropriate method on the agent's physical feature classes representing one or more physical features of the agent's body.

### Mobile Software Components

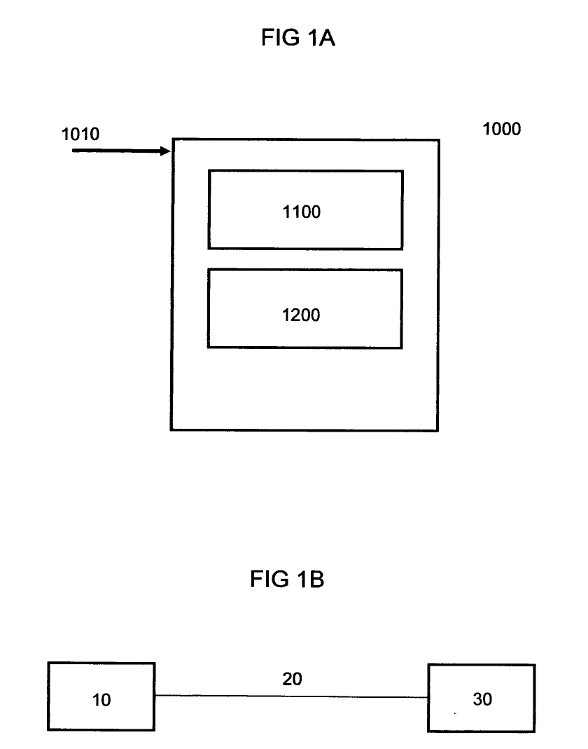

With reference to FIG. 1A, a software object 1000 is the basis for building the mobile agent, the software object comprising code (Java, C#, C, and so forth) that will execute by emulation or by an interpreter within a server of any computer in a network. The object comprises a pointer or reference 1010 that specifies an entry point into the executable code. Executable code (methods defined on the object 1000) is indicated by 1100 and data is indicated by 1200.

With reference to FIG. 1B, an agent comprising objects (FIG. 1A) resides on a computer 10 in a network 20, and is serialized and transmitted over the network 20 to a second computer 30, where the object is deserialized and executed or stored in a database.

### Computing Environment

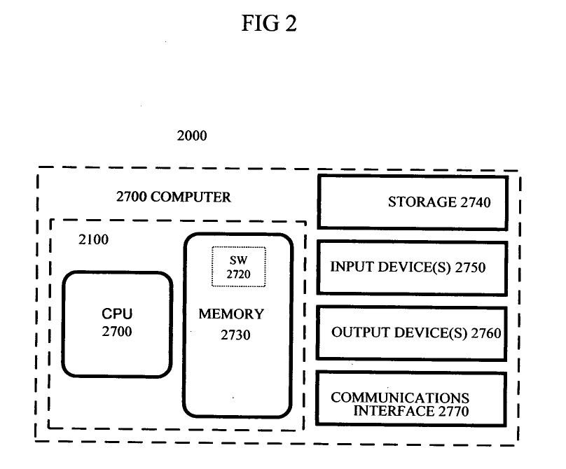

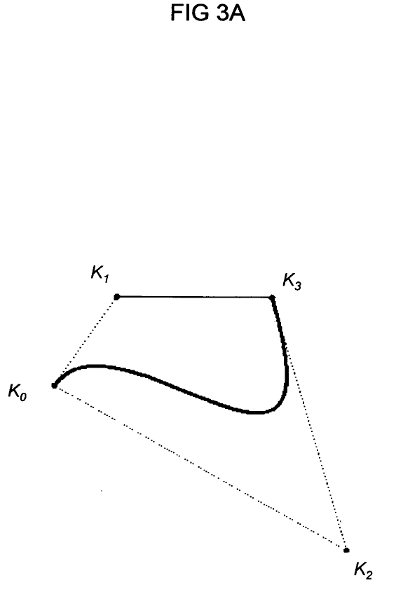

With reference to FIG. 2, mobile agent may be implemented (created, compiled, serialized, transmitted, deserialized, stored and executed); for example, within a computing environment 2000, which includes at least one processing unit 2700 and memory 2730. In FIG. 2, this most basic configuration 2000 is included within a dashed line. The processing unit 2700 executes computer-executable instructions and may be a real or a virtual processor. In a multi-processing system, multiple processing units execute computer-executable instructions to increase processing power. The memory 2730 may be volatile memory (e.g., registers, cache, RAM), non-volatile memory (e.g., ROM, EEPROM, flash memory, etc.), or some combination of the two. The memory 2730 stores executable software—instructions and data 2250—written and operative to execute and implement the software applications required for an interactive environment supporting practice of the invention.

The computing environment may have additional features. For example, the computing environment 2000 includes storage 2740, one or more input devices 2750, one or more output devices 2760, and one or more communication connections or interfaces 2770. An interconnection mechanism (not shown) such as a bus, controller, or network interconnects the components of the computing environment to the Internet, where the agent may be serialized and transmitted from server to server. Typically, operating system software (not shown) provides an operating environment for other software executing in the computing environment, and coordinates activities of the components of the computing environment.

The storage 2740 may be removable or non-removable, and includes magnetic disks, CD-ROMs, DVDs, or any other medium which can be used to store information and which can be accessed within the computing environment. For example, the storage may store merchant's databases and serialized objects. The storage 2740 also stores instructions for the software 2720, such as software for operating systems and web servers.

The input device(s) 2750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 2760 may be a display, printer, speaker, or another device that provides output from the computing environment.

The communication interface 2770 enable the operating system and software applications to exchange messages over a communication medium with the sensor device, and servo-mechanisms in various instantiations of the apparatus of the invention. The communication medium conveys information such as computer-executable instructions, software objects and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 2770 is used to communicate with other devices and computers. For example, the interface 2770 may be attached to a network, such as the Internet, whereby the computing environment 2000 interchanges command, control and feedback signals with other computers, devices, and machinery.

### Object Methods and Agent Physicality

The physical feature classes are used to build physical representations of the agent that are manifested on desktops. The physical body of the agent is expressed in terms of bytecode objects that have methods, when called render mathematical functions, that when called, draw that body part. Mathematical functions used may be any function used to represent geometric curves, surfaces or volumes. For example, splines are mathematical functions that describe images—curves and surfaces.

### Representing Aspects of the Shopper's Physicality Using 3D Computer Graphics

3D computer graphics (in contrast to 2D computer graphics) are graphics that utilize a three-dimensional representation of geometric data that is stored in the computer for the purposes of performing calculations and rendering 2D images. Such images may be for later display or for real-time viewing. A variety of mathematical functions, such as splines, may be used to represent curves, surfaces and volumes.

In the mathematical field of numerical analysis, a Bézier curve is a parametric curve important in computer graphics. Generalizations of Bézier curves to higher dimensions are called Bézier surfaces, of which the Bézier triangle is a special case. Bézier curves are widely used in computer graphics to model smooth curves. As the curve is completely contained in the convex hull of its control points, the points can be graphically displayed and used to manipulate the curve intuitively.

Affine transformations such as translation, scaling and rotation can be applied on the curve by applying the respective transform on the control points of the curve. Quadratic and cubic Bézier curves are most common; higher degree curves are more expensive to evaluate. When more complex shapes are needed, low order Bézier curves are patched together. This is commonly referred to as a “path” in programs like Adobe Illustrator or Inkscape. These poly-Bézier curves can also be seen in the SVG file format. To guarantee smoothness, the control point at which two curves meet and one control point on either side must be collinear.

The simplest method for scan converting (rasterizing) a Bézier curve is to evaluate it at many closely spaced points and scan convert the approximating sequence of line segments. However, this does not guarantee that the rasterized output looks sufficiently smooth, because the points may be spaced too far apart. Conversely it may generate too many points in areas where the curve is close to linear. A common adaptive method is recursive subdivision, in which a curve's control points are checked to see if the curve approximates a line segment to within a small tolerance. If not, the curve is subdivided parametrically into two segments, 0≦t<0.7 and 0.7≦t<1.0 and the same procedure is applied recursively to each half. There are also forward differencing methods, but great care must be taken to analyze error propagation. Analytical methods where a spline is intersected with each scan line involve finding roots of cubic polynomials (for cubic splines) and dealing with multiple roots, so they are not often used in practice.

### Structure of the Agent

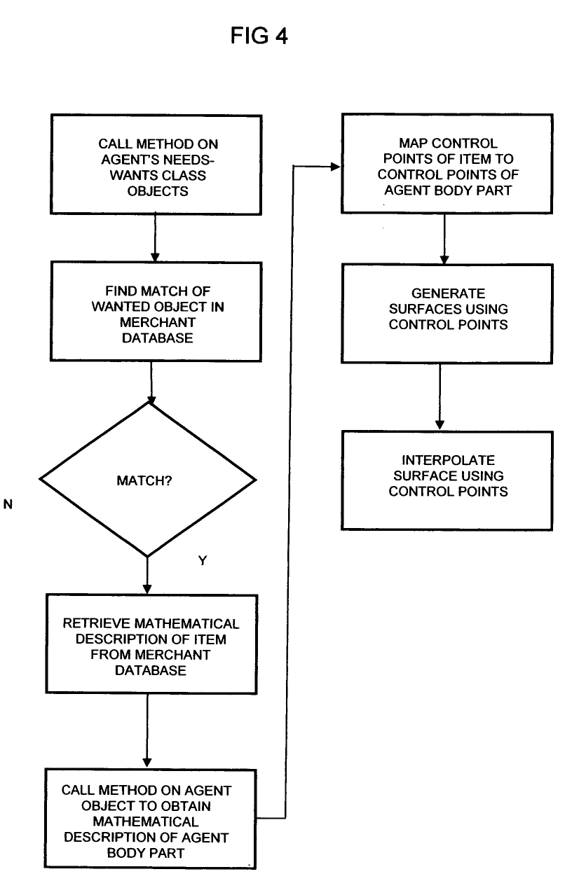

While each of the agent's body parts are expressed in terms of a collection of bytecode classes, a single overall bytecode object describes the relationship of body parts, such as the positioning of arms, legs, head and so forth. Specifically, with reference to FIG. 4, the agent is comprised of a hierarchical collection of bytecode executable objects. With reference to FIG. 4, the body of the agent 4100 is represented by an object 4110, which in turn is related to by “has” arms 4210, and legs 4220. The arms 4210, in turn are related to the agent's torso.

Each of the agent classes are endowed with methods that may be called by a server on the Internet. For example to obtain the physical extent of a body part, such as waist size or length or arm or leg, the method on the object may be called. Or a server may call a method on the object (body part) of the agent to render or describe elements of the agent's body.

In one example, the agent may visit a web-site that sells bracelets. Images of bracelets sold by the web-site are expressed in terms of spline functions. For example, the merchant's catalog of jewelry has been processed and the images are expressed in terms of spline functions and stored in a spline image database.

When the agent object visits the merchant's web-site, the merchant server queries the agent's objects of the class of interests and desires. Assuming the agent object responds with “bracelet” of certain specifications, the merchant's server searches the web-site database, and finds a bracelet fitting the agent's needs or wants.

The merchant server then queries the agent's physical body classes to retrieve a mathematical spline description of the agent's right wrist. Using the retrieved spline and the mathematical (spline) description of the bracelet, the merchant's computer maps the spline function of the bracelet to the agent's wrist. Or, as an alternative, the spline function describing the bracelet is stored in a “shopping bag” class and returned to the computer of the agent's origination, where the bracelet is mapped to the agent's wrist, then displayed on the origination computer.

### Mapping of Items Purchased at a Merchant's Web-Site

As an example of mapping an item for purchase to the agent's body, Bezier curves will now be described. Although the description uses Bezier curves, this should not be construed as a limitation of the disclosure of the exemplary embodiment of the invention.

Cubic Bezier curves are commonly used elements in graphics systems. Cubic Bezier curves are used in Adobe's Postscript, for example, and in many programs that output primarily PostScript, such as Adobe Illustrator and Macromedia FreeHand. Bezier curves in general have mathematical properties that make them ideal for constructing vector-based graphics.

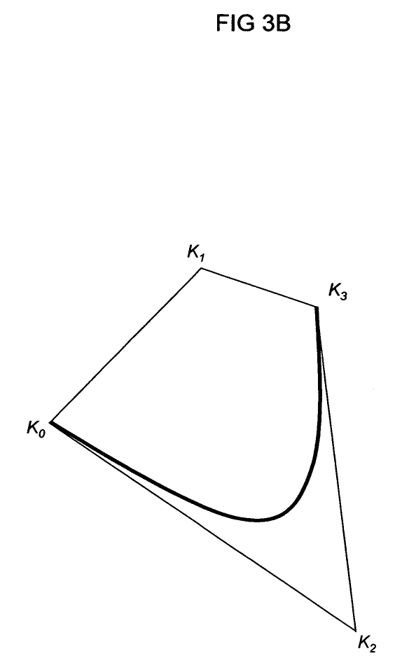

A Bezier curve is described in terms of a control polygon, whose vertices are called control points. An example of a cubic Bezier curve is shown in FIG. 3A A third degree Bezier curve begins at exactly the first control point K₀ and terminates at exactly the last control point K₃. A cubic Bezier curve is described by four points: the first and fourth describe the endpoints of the curve; the second and third control the tangents of the curve at the endpoints, as well as the magnitude of the curvature. This property of Bezier curves makes it trivial to construct more complicated curves, since two curves may be connected simply by making the last point of one curve coincident with the first point of another. Another property of the Bezier curve is that it leaves its first control point on a tangent to the line segment between the first and second control points and enters the final control point on a tangent to the line segment connecting the last and next-to-last control point. A Bezier curve is also completely bounded by the convex hull of its control points [K₀, K₁, K₂, K₃]. The convex hull is a complex polygon enclosing all of the control points. This bounding property turns out to be quite useful in practice since a Bezier curve is invariant under affine transformations. An affine transformation is a scale, shear, translation, rotation, or any combination thereof. Since a Bezier curve is invariant under such transformations, transforming the control points of a curve has the same effect as transforming the curve itself.

FIG. 3B shows the Bezier curve of 3A, with changed control points [K₀, K₁, K₂, K₃]. By changing the position of the control points (convex hull) of the Bezier curve in FIG. 3A to the positions shown in FIG. 3B, the Bezier curve of FIG. 3A has been transformed to the Bezier curve in FIG. 3B.

If the control points are defined in terms of coordinates in a four dimensional mathematical space, the control points of FIG. 3A are mapped to the control points in FIG. 3B by a unique non-singular 4×4 matrix (mathematical operator).

In order to map a physical article (for example a bracelet) to a body part of the agent (such as the agent's wrist), the following algorithm is used (shown in flowchart form in FIG. 4.)

An agent visits a merchant's web-site. The merchant server calls a method on the agent's object classes corresponding to the agent's needs, wants and desires.

Data returned from the method call is used to query a merchant database storing items for sale by the merchant.

If the database query is satisfied, the query returns a description of the item, including a Bezier curve or surface description of the item. Next a description of the agent body part is retrieved, the description including a Bezier curve or surface description of the agent part.

A mathematical transform is used to transform the control points of the item to the control points of the agent's body part.

When the agent returns to the user, the agent's body is rendered (using Bezier curves or surfaces) in conjunction with the rendering of the transformed item from the merchant web-site.

### A Variant of the Exemplary Embodiment

In a variant of the exemplary embodiment, a merchant catalog server is programmed to store the catalog of at least one merchant. All items sold by the merchant are expressed in mathematical terms, for example, as spline functions.

The agent visits the catalog server, where the catalog server queries the agent's wants or desires classes. Upon determining a match between some item in the catalog, the object of the matching item calls the appropriate body part class, which returns a mathematical description of the body part or parts

### DISCLOSURE SUMMARY

A shopping agent has been disclosed in an exemplary embodiment. The shopping agent represents the shopper by being configured with a representation of the shopper's needs and with representations of the shopper's budget and physical aspects of the shopper's body. The teachings of this disclosure may be used to instruct a reader to create other embodiments that are consistent with the spirit and scope of the claims that follow.

What is claimed is:

1. A computer network comprising a plurality of computers, the network having:
a software agent representing a user of the network, the agent transportable and executable within the network, the agent comprising a mathematical expression of a part of the user's body;
a web server having a database storing a record representing an item that may be worn on the user's body part, wherein the record also stores a mathematical representation of the item, and;
a mathematical function that maps the mathematical representation of the item to the mathematical representation of the user's body part.
